(19) United States
(12) Patent Application Publication
(10) Pub. No.: US 2026/0102015 A1
(43) Pub. Date: Apr. 16, 2026

(54) FOLDABLE FOOD WARMING PAD

(71) Applicant: Guangdong Willing Technology Corporation, Huizhou (CN)

(72) Inventors: Jingnong YE, Huizhou (CN); Shifa LUO, Huizhou (CN); Jinshi HE, Huizhou (CN)

(73) Assignee: Guangdong Willing Technology Corporation, Huizhou (CN)

(21) Appl. No.: 19/033,510

(22) Filed: Jan. 22, 2025

(30) Foreign Application Priority Data
Oct. 15, 2024 (CN) 202422493137.7

(51) Int. Cl. A47J 36/24

(52) U.S. Cl. CPC A47J 36/2483

(57) ABSTRACT

A foldable food warming pad includes a panel and a controller, the panel is bendable, and the panel is provided with a heat source. The controller includes a housing, a main control circuit board and a battery. The panel includes a first surface and a second surface arranged in opposite directions, the second surface is provided with a plurality of supporting bodies, a thickness of the panel is smaller than a thickness of the housing, and a height of the supporting bodies is configured to compensate for a thickness difference between the panel and the housing.

### CROSS REFERENCE TO RELATED APPLICATIONS

This application claims priority benefits to Chinese Patent Application No. 2024224931377, filed on Oct. 15, 2024; the contents of which are incorporated herein by reference.

### TECHNICAL FIELD

The present disclosure relates to a foldable food warming pad.

### BACKGROUND

A food warming pad (mat) can be used in various scenarios, such as homes and restaurants, especially during gatherings and in cold seasons, to keep dishes warm.

### SUMMARY

A first aspect of the present disclosure provides a foldable food warming pad, including: a panel, being bendable and provided with a heat source; and the heat source being configured to form a heating area on a first surface of the panel; and a controller, including: a housing, a main control circuit board, and a battery; the main control circuit board and the battery being arranged in the housing; the heat source and the battery being electrically connected to the main control circuit board respectively; and the panel being fixedly connected to a first side of the housing. The panel includes a second surface opposite to the first surface, the second surface of the panel is provided with a plurality of support bodies, the plurality of support bodies are parallel to the first side of the housing, and the plurality of support bodies extend in a direction away from the second surface of the panel, a thickness of the panel is smaller than a thickness of the housing, and a height of the plurality of support bodies is configured to compensate for a thickness difference between the panel and the housing.

A second aspect of the present disclosure provides a foldable food warming pad, including: a panel, being bendable and provided with a heat source; the heat source being configured to form a heating area on a first surface of the panel; and a controller, including a housing; a main control circuit board being arranged in the housing, the heat source being electrically connected to the main control circuit board, and the panel being fixedly connected to a first side of the housing. The controller is provided with a power input interface, the power input interface is electrically connected to the main control circuit board, and the power input interface is configured to establish an electrical connection with the main control circuit board from an external power source. The panel includes a second surface opposite to the first surface, the second surface of the panel is provided with a plurality of support bodies, the plurality of support bodies are parallel to the first side of the housing, and the plurality of support bodies extend in a direction away from the second surface of the panel. A thickness of the panel is smaller than a thickness of the housing, and a height of the support bodies is configured to compensate for a thickness difference between the panel and the housing.

### BRIEF DESCRIPTION OF THE DRAWINGS

The drawings constituting a part of the present disclosure are configured to provide a further understanding of the present disclosure. The embodiments of the present disclosure and their descriptions are used for explaining and do not constitute an improper limitation on the present disclosure.

FIG. 1 is a perspective view of a food warming pad in accordance with the embodiments of the present disclosure.

FIG. 2 is an exploded perspective view of FIG. 1.

FIG. 3 is a bottom view of FIG. 1.

FIG. 4 is a side view of FIG. 1.

FIG. 5 is a side view of the food warming pad in FIG. 4 in a curled state.

FIG. 6 is a partial enlarged view of area A in FIG. 3, which shows a support area formed by a plurality of support columns.

FIG. 7 is another perspective view of FIG. 6.

FIG. 8 is a perspective view of a food warming pad in accordance with the embodiments of the present disclosure.

FIG. 9 is a perspective view of the food warming pad shown in FIG. 8, which shows a heat dissipation area 11 and an expansion area of a heat transfer plate and their distribution.

FIG. 10 is a bottom view of FIG. 9.

FIG. 11 is another perspective view of FIG. 9.

FIG. 12 is a sectional view taken along line BB in FIG. 9.

FIG. 13 is a partial enlarged view of area D in FIG. 12, which shows the connection structure between a support plate, a heat source, and a heat transfer plate, and the connection structure between the support plate and a housing of a controller.

FIG. 14 is a partial enlarged view of area C in FIG. 9, which shows a layout of control and display components of a control panel.

FIG. 15 is a perspective view of a food warming pad and an application scenario in accordance with the embodiments of the present disclosure.

### DETAILED WAY

The present disclosure may be described in detail below with reference to the accompanying drawings and in conjunction with various embodiments. Each example is provided to explain but not limit the present disclosure. In fact, it may be clear to those of ordinary skill that modifications and variations may be made without departing from the scope or spirit of the present disclosure. For example, a feature shown or described as part of some embodiments may be used according to some embodiments to produce yet some embodiments. Therefore, it is intended that the present disclosure includes such modifications and variations within the scope of the appended claims and their equivalents.

In the description of the present disclosure, the terms “longitudinal”, “lateral”, “upper”, “lower”, “front”, “back”, “left”, “right”, “vertical”, “horizontal”, “top”, “bottom” and the like indicate the orientational or positional relationship based on the orientational or positional relationship illustrated in the drawings, which is only for the convenience of describing and eliminates the require the present disclosure to be constructed and operated in a specific orientation, and therefore cannot be understood as limiting the present disclosure. The terms “connected”, “connecting” and “arranged” used in the present disclosure should be understood in a broad sense. For example, it may be a fixed connection or a detachable connection; it may be directly connected or indirectly connected through an intermediate component; it may also be a wired electrical junction, a radio connection, or a wireless signal connection. For those of ordinary skill in the art, the specific meanings of the above terms may be understood according to the specific circumstances.

One or more examples of the present disclosure are illustrated in the attached drawings. Numbers and letter signs are used in the detailed description to refer to features in the drawings. Similar signs in the drawings and descriptions have been configured to refer to similar parts of the present disclosure. As used herein, the terms “first”, “second” and “third” are used interchangeably to distinguish one component from another and are not intended to indicate the position or importance of individual components.

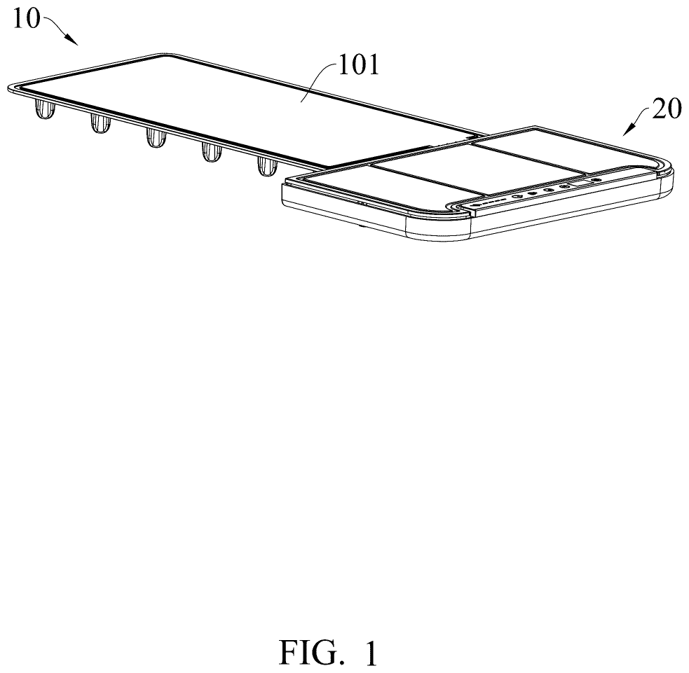

As shown in FIG. 1, according to some embodiments of the present disclosure, a food warming pad is provided, including a panel 10 and a controller 20. A first end of the panel 10 is connected to a first side of the controller 20.

The panel 10 is provided with a heat source 101, and the heat source 101 has a heating area. The heat source 101 includes a heating element, and the heating element includes but is not limited to at least one of an alloy-based heating wire and a graphene-based heating film. The heat source 101 can also be any commercially available products that can heat and warm the food on the panel 10. The heat source 101 can be built into the panel 10 or arranged at a bottom of the panel 10, as long as the heat source 101 can be installed on the panel 10 and can transfer heat to the food on the panel 10.

In some embodiments, the panel 10 includes a support plate 102, and the heat source 101 is placed on one side of the support plate 102. The support plate 102 is connected to the controller 20. Considering the toughness and strength of the panel 10, its structure and material can be proposed according to targeted implementation plans as required by different application scenarios. In addition, the restrictions of the panel 10 on the heat source 101 can be further reduced. In other words, the heat source 101 mainly provides a heating function, and other functions are achieved by the support plate 102. The heat source 101 can be developed specifically according to actual needs. Existing available heat source 101 can also be purchased, and the support plate 102 can be adaptively adjusted according to the specifications of the heat source 101, which include but are not limited to width, length, thickness, etc. of the heat source 101.

The controller 20 is provided with a main control circuit board 203. In some embodiments, the main control circuit board 203 is provided with a main control chip (such as an MCU chip), a power management circuit, and a control circuit. The heat source 101 is electrically connected to the main control circuit board 203. The controller 20 is provided with a power supply, and the power supply is electrically connected to the main control circuit board 203. In some embodiments, the power supply includes a battery 204, and the battery 204 includes a primary battery and a rechargeable battery. The main control circuit board can control a on and off state of the heat source 101, and control the heat source 101 to heat to a preset temperature when it is powered on. In some embodiments, the controller 20 is provided with a control board 205, the control board 205 is electrically connected to the main control circuit board 203. A control element is provided on the control board 205. The control board 205 can send instructions to the main control circuit board 203 to make the main control circuit board 203 change the working state of the heat source 101.

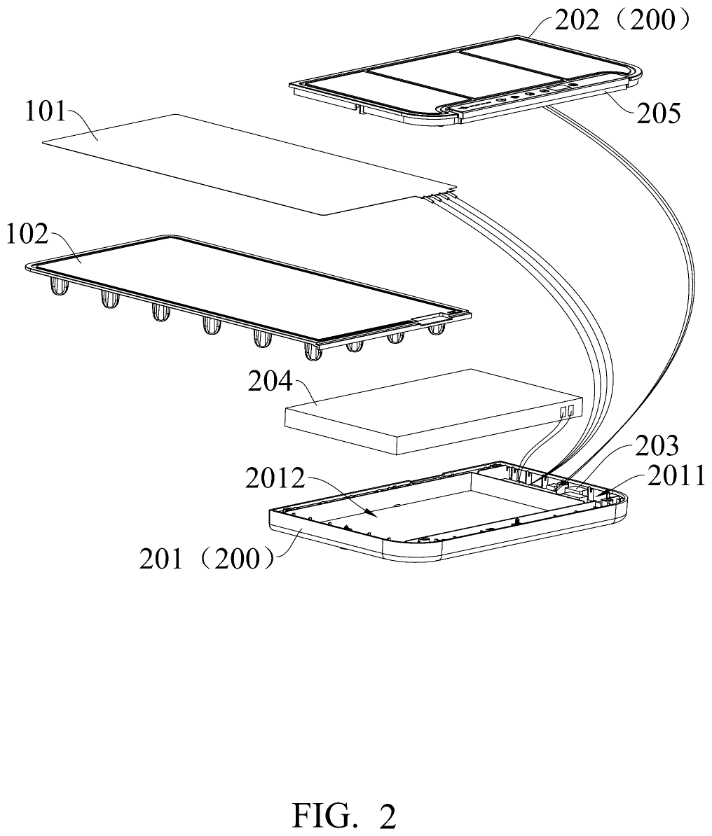

As shown in FIG. 2, in some embodiments, the controller 20 includes a housing 200. The housing 200 includes a first half housing 201 and a second half housing 202. The first half housing 201 is defined with a first accommodating cavity 2011 and a second accommodating cavity 2012, the battery 204 is placed in the first accommodating cavity 2011, and the main control circuit board is placed in the second accommodating cavity 2012. The control board 205 is fixedly arranged on an outer side of the second half housing 202.

In some embodiments, the first half housing 201 and the second half housing 202 are detachably connected, for example, by snap-fitting or threading. The first half housing 201 and the second half housing 202 can also be fixedly connected, for example, by gluing, hot-melting, or welding.

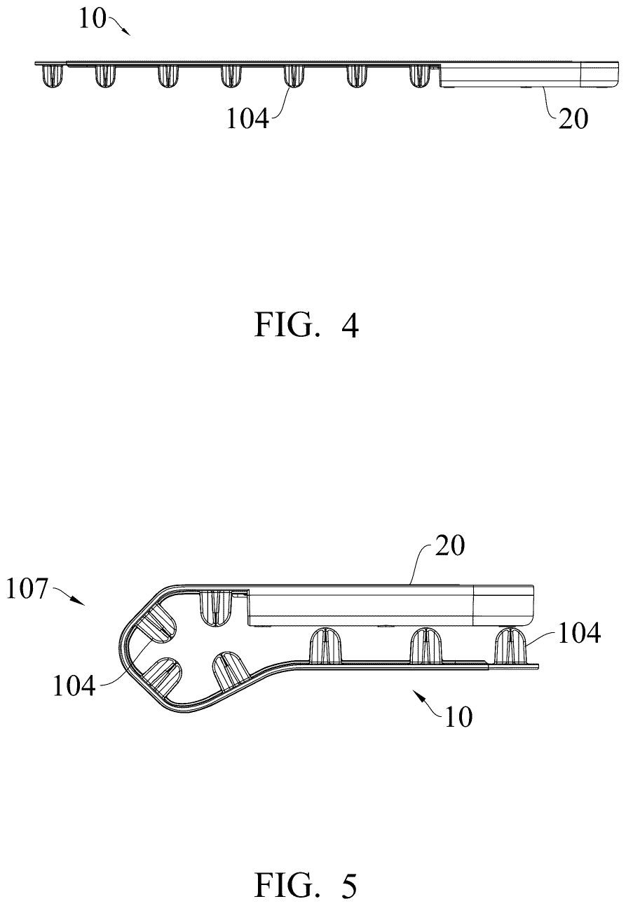

The application scenarios of the warming pad are wide, such as at home, in restaurants, outdoors, etc. In addition to the heating function, storage and carrying need to be considered. For storage, the space occupied by the warming pad is mainly concerned; for carrying, in addition to paying attention to the occupied space, the overall weight also needs to be concerned. In this case, as shown in FIG. 4, while ensuring that the heating area remains unchanged, the weight can be reduced by reducing the thickness of the panel 10. As can be seen from FIG. 4, due to the need for an internal power supply in the controller 20, the reduction in the size of the controller 20 is limited, resulting in the panel 10 being thinner than the controller 20.

In some embodiments, as shown in FIG. 4, a top surface of the panel 10 and a top surface of the controller 20 are substantially defined by a same plane. The purpose of this is that the top surface of the warming pad is relatively flat, a larger carrying area facilitates for placing the food or the container of the food, and the movements of the food or the container of the food are not hindered. In addition, the flat surface appears simple and not messy, improving the mood of dining. In order to solve the thickness difference between the panel 10 and the controller 20, a bottom surface of the panel 10 is provided with a support structure for compensating the above thickness difference.

In order to reduce the space occupied by the food warming pad when it is stored, the embodiments of the present disclosure provide a folding solution. The volume of the controller 20 is relatively fixed due to the need for a built-in power supply, and most of the electronic components in the controller 20 make it difficult to be folded. Therefore, the folding solution mainly focus on improvements to the panel 10. Considering that the heat source 101 is restricted to be folded at any angle, or in other words, folding at a large angle may damage the structure of the heat source 101 and reduce the service life of the heat source 101. Therefore, the panel 10 can be arranged around the outside of the controller 20 in a winding manner, which can not only reduce the overall volume of the food warming pad, but also prevent the damage of the heat source 101 due to excessive bending of the panel 10.

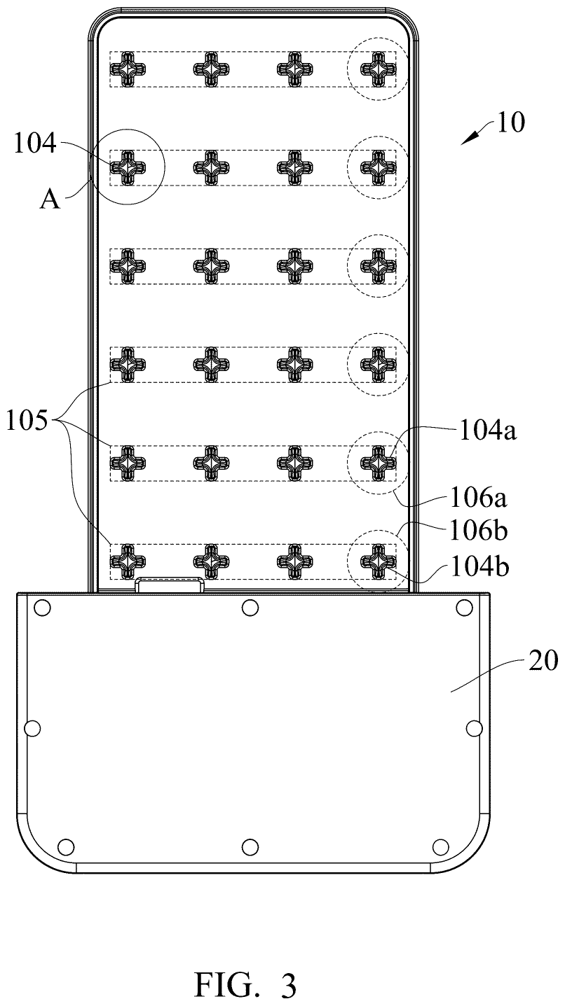

In some embodiments, the panel 10 is made of a flexible material so that it can be bent. As shown in FIG. 3 and FIG. 4, in some embodiments, the support structure includes a plurality of support columns 104. First ends of the support columns 104 are fixedly connected to the bottom surface of the panel 10, and the height of the support columns 104 can compensate for the thickness difference between the panel 10 and the controller 20. The plurality of support columns 104 are divided into a plurality of rows, each row includes several support columns 104, and each row of support columns 104 is arranged in a straight line and forms a support body 105. The plurality of support bodies 105 are distributed in parallel and extends from the first surface of the panel 10 to a direction away from the controller 20. As shown in FIG. 5, when stored, the panel 10 can be selectively curled toward the bottom of the controller 20 and form a curved surface structure 107. In some embodiments, the panel 10 can be completely rolled around the outside of the controller 20. When the panel 10 is curled, second ends of the support columns 104 can abut against an outer wall of the controller 20. In the example shown in FIG. 5, the panel 10 forms four folded corners after being rolled. Under the influence of the support column 104, the bending amplitude of the panel 10 is limited. The bending amplitude not being too large protects the structure of the heating source 101. In addition, it can be seen from FIG. 5 that the thickness of the controller 20 and the height of the support column 104 can be appropriately adjusted to further reduce the bending amplitude, so as to reduce the influence of the folded angle on the heating source 101 and the panel 10.

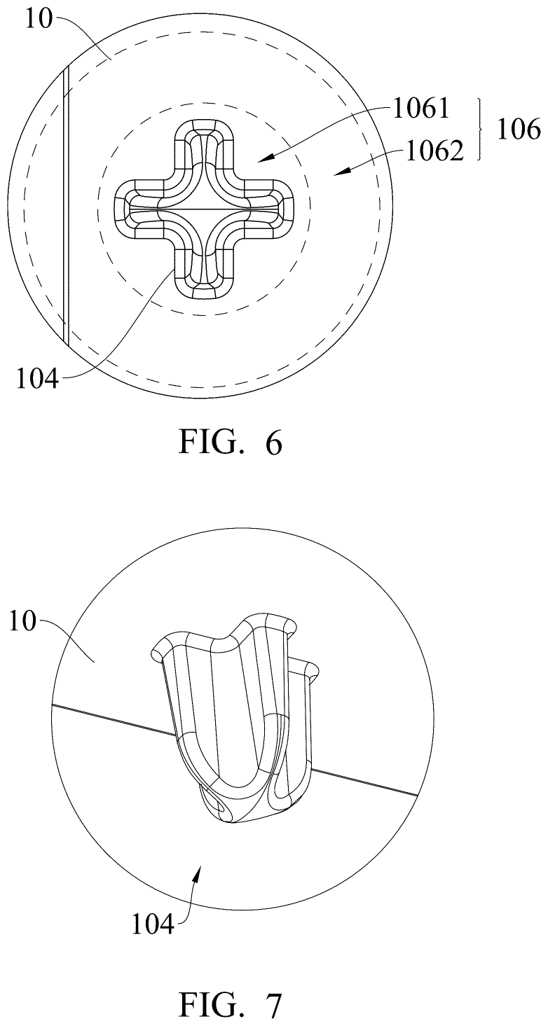

In addition, as shown in FIG. 6, a first end of a support column 104 is fixed to the panel 10, and the first end of the support column 104 forms a support area 106 on the contact surface of the panel 10, and the support area 106 expands from a center of the support column 104, and the support area 106 may limit the bending amplitude of the panel 10 in this area. The support area 106 includes a first area 1061 and a second area 1062, which are divided by a distance of a boundary of each of the first area 1061 and the second area 1062 to the support column 104. When the panel 10 is folded, the first area 1061 of the panel 10 is not bent or the bendable range is small, and the bendable range of the second area 1062 of the panel 10 gradually increases outwardly. In some embodiments, the contact area of the support column 104 on the panel 10 affects the range of the support area 106, and the contact area is proportional to the range of the support area 106.

In some embodiments, the support column 104 can be designed as a platform, and a cross-sectional area of the support column 104 gradually decreases from the first end to the second end of the support column 104. This solution can ensure that the support area 106 is sufficiently large and can also reduce the weight of the support column 104. In other embodiments, as shown in FIG. 7, the support column 104 can be designed as a cross bone having a cross-shaped cross-section. It can also be presented as any of L-shaped, T-shaped, Y-shaped, and H-shaped.

In some embodiments, as shown in FIG. 3, the bendable range of two adjacent rows of support columns 104 is limited by the distance between the two rows and the boundary of the support area 106 formed by the support column 104. Taking the first support column 104a and the second support column 104b in FIG. 3 as an example, the first support column 104a forms a first support area 106a, and the second support column 104b forms a second support area 106b. When the boundary of the support area 106 remains unchanged, the distance between two adjacent rows can be adjusted, thereby limiting the bendable range of the two adjacent rows of the support bodies on the panel 10. When the distance between two adjacent rows remains unchanged, the boundary of the support area 106 formed by the support column 104 can be adjusted, thereby limiting the bendable range of the two adjacent rows of the support bodies on the panel 10.

In order to reduce the influence of the bending angle on the heat source 101 and the panel 10, a targeted design can also be made. In some embodiments, less heating material is arranged at a position with a larger bending amplitude to reduce the influence of the bending on the heat source 101. More heating materials is arranged in the support area 106 to improve the heating effect of the heat source 101.

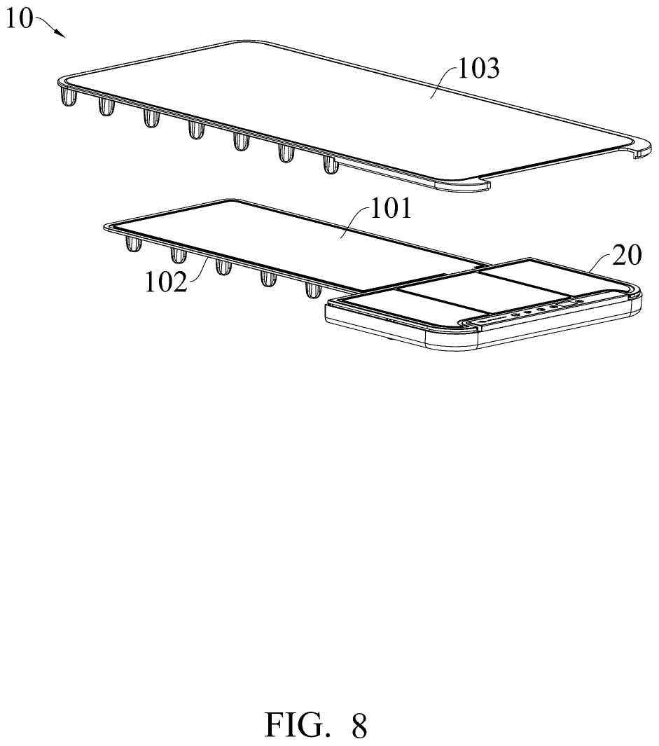

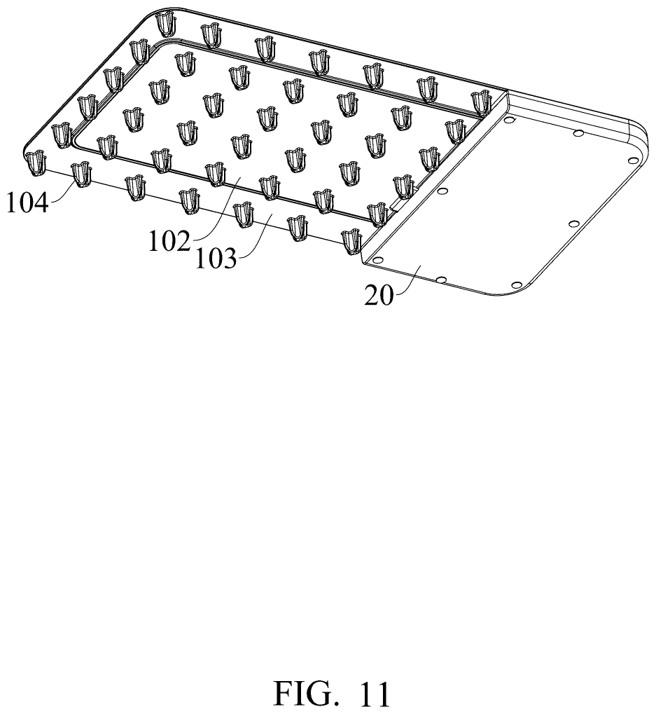

As shown in FIG. 8 to FIG. 11, in some embodiments, a heat transfer plate 103 is arranged on the side, facing the food to be heated, of the panel 10. The heat transfer plate 103 is made of a flexible material so as to be bent. The heat transfer plate 103 completely covers the heat source 101, providing effective protection for the heat source 101, and extending the service life of the heat source 101.

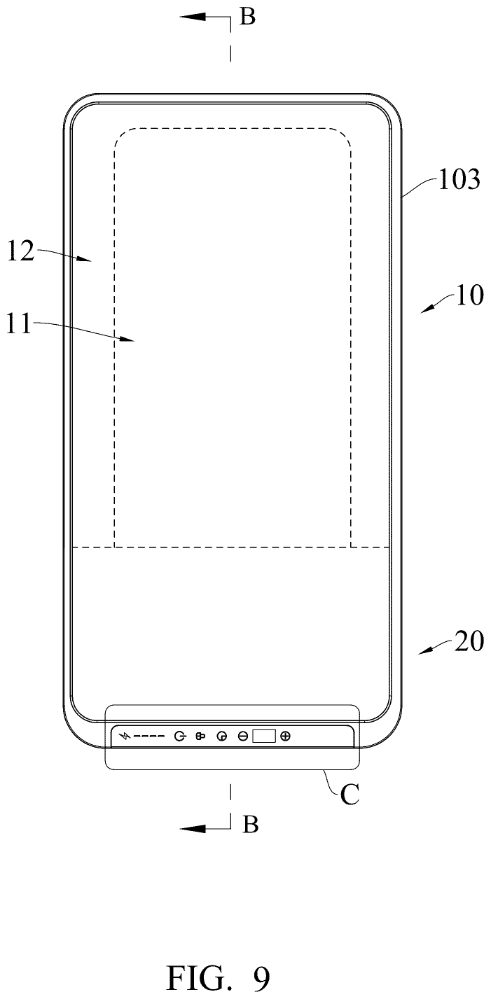

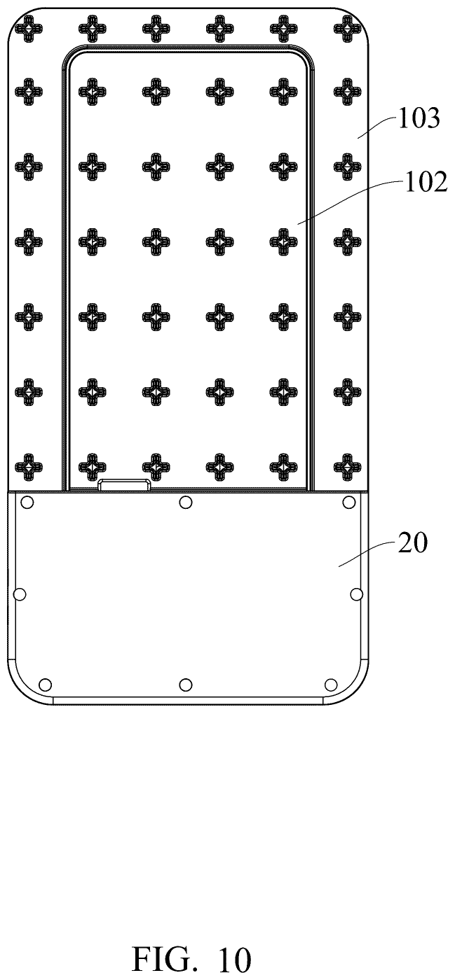

In addition, in some embodiments, as shown in FIG. 9 and FIG. 10, an area of the heat transfer plate 103 is greater than an area of the heat source 101. In some embodiments, the heat source 101 and the support plate 102 are arranged in a middle portion of the heat transfer plate 103, and the heat transfer plate 103 is divided into a heat dissipation area 11 and an extension area 12. An area of the heat dissipation area 11 corresponds to the area of the heating source 101, and the extension area 12 is arranged at a periphery of the heat dissipation area 11. Compared with the heat dissipation area 11, the extension area 12 can effectively expand the area for bearing the heating source 101. Moreover, a surface temperature of the extension area 12 is relatively low, which is safer for a user. In addition, when the temperature of the heat dissipation area 11 is high and the food warming pad needs to be moved, it is safer to hold the extension area 12. In some embodiments, the extension area 12 of the heat transfer plate 103 is also provided with one or more support columns 104, allowing the extension area 12 of the heat transfer plate 103 to provide effective support for the items thereon.

In addition, in some embodiments, the heat transfer plate 103 has different thicknesses at different regions. For example, the thickness of the heat dissipation area 11 of the heat transfer plate 103 is relatively thinner to improve heat transfer; the thickness of the extension area 12 of the heat transfer plate 103 is relatively thicker to improve support strength. In some embodiments, the heat dissipation area 11 and the extension area 12 of the heat transfer plate 103 are made of different materials. For example, the heat dissipation area 11 is made of a material with good thermal conductivity, while the extension area 12 is made of a material with good rigidness.

In addition, in some embodiments, the extension area 12 covers at least a portion of the controller 20, allowing the heat source 101 and the upper surface of the controller 20 to form one piece and making the surface of the food warming pad more concise. In addition, dustproof, waterproof, and wear-resistant properties of the food warming pad is also improved.

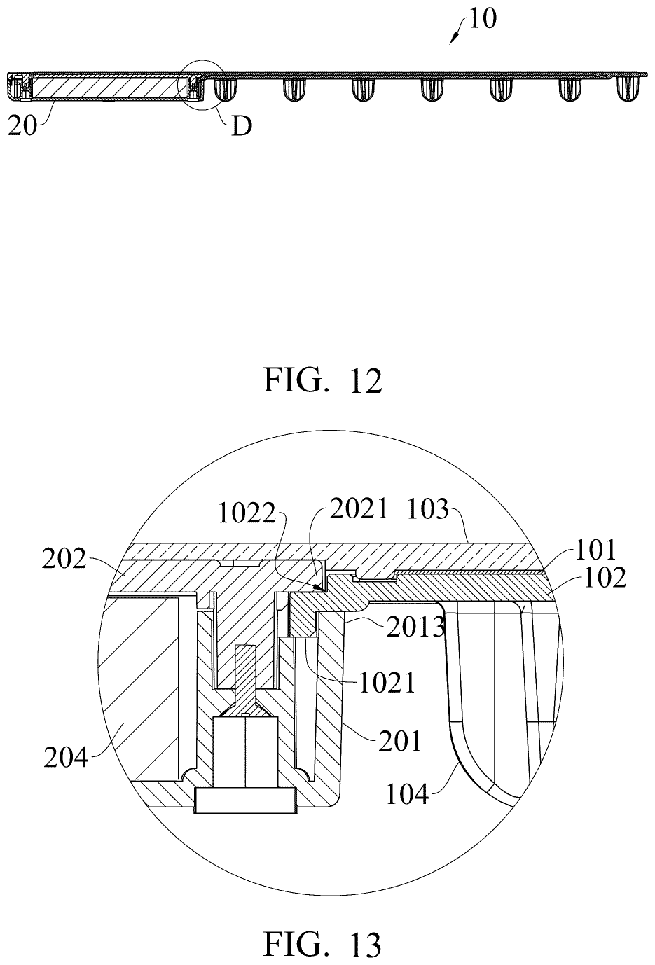

As shown in FIG. 9, FIG. 12 and FIG. 13, in some embodiments, the heat source 101 is sandwiched between the support plate 102 and the heat transfer plate 103. The support plate 102 is detachably connected to the housing 200 of the controller 20. A first end, facing the controller 20, of the support plate 102 extends into the housing 200 of the controller 20, and is sandwiched between a first edge 2013 of a first half housing 201 and a second edge 2021 of the second half housing 202. The first end of the support plate 102 is provided with a strip 1021 extending toward the first half housing 201 and is defined with a groove 1022 extending toward the second half housing 202. The strip 1021 is mutually engaged with the first edge 2013, and the groove 1022 is mutually engaged with the second edge 2021, so that the support plate 102 is secured to the housing 200 of the controller 20. In some embodiments, the support plate 102 and the first half housing 201 of the controller 20 are an integral structure, or the support plate 102 is fixedly connected to the housing 200 by bonding, welding, melting, etc.

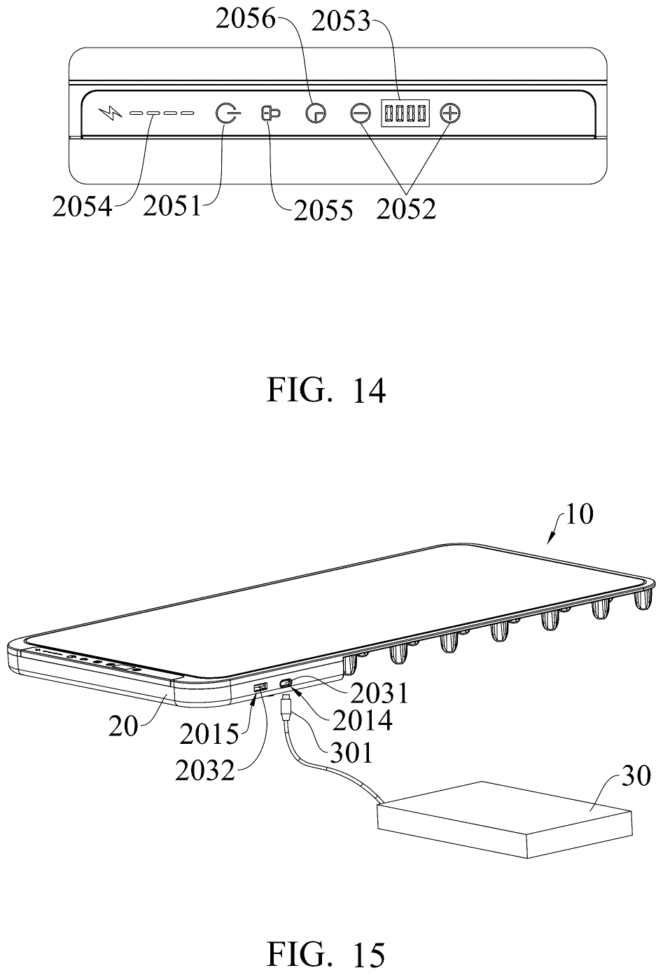

As shown in FIG. 14, a key and display layout of the control panels 205 is provided. The control panel 205 is provided with a switch key 2051, two temperature adjustment keys 2052, a digital tube 2053 arranged between the two temperature adjustment keys 2052, a lock key 2055, a timing key 2056 and an indicator light 2054. The switch key 2051 is configured to control the power on and off of the heat source 101. The lock key 2055 is configured to lock other operations of the control board 205, rendering them unusable, or release the aforementioned lock. The temperature adjustment key 2052 is configured to set the heating temperature; the heat source 101 can feed back a current temperature to the main control chip when heating. A sensor can be set separately to monitor the temperature of the heat dissipation area 11, and the sensor is electrically connected to the main control circuit board 203. When the circuit on the main control circuit board 2 detects that the temperature of the heat dissipation area 11 reaches the preset temperature, the corresponding operation is performed. The timing key 2056 is configured to control the operation time. The indicator light 2054 is configured to display the current power of the power supply, the charging/discharging status, etc. As shown in FIG. 15, in some embodiments, a charging interface 2014 is provided on the housing 200 of the controller 20, and a power input interface 2031 is provided on the main control circuit board 203. An external power output interface can be inserted into the charging interface 2014 and electrically connected to the power input interface 2031. The external power supply includes a mobile charging device and a power adapter. As shown in the FIG. 15, a plug 301 of the mobile charging device can be plugged into the charging interface 2014, powering the food warming pad or/and charging the battery 204 of the food warming pad. In some embodiments, the battery in the controller is not a necessary component. When the internal battery is removed or taken out, the food warming pad can be powered by an external power supply, which does not affect the heating effect of the food warming pad. In some embodiments, the power input interface includes a USB interface and a DC circular interface.

As shown in FIG. 15, in some embodiments, the housing of the controller 20 is provided with a power supply interface 2015, and the main control circuit board 203 is provided with a power output interface 2032. In some embodiments, the food warming pad can power external devices. For example, one end of a charging cable can be inserted into the power supply interface 2015 and electrically connected to the power output interface 2032, and another end of the charging cable is connected to the mobile phone, thereby being charged by the food warming pad. In some embodiments, the power output interface includes a USB interface and a DC circular interface.

The above description is only some embodiments of the present disclosure and is not intended to limit the scope of the present disclosure. Any equivalent changes or modifications made according to the structure, characteristics and principles described in the protection scope of the present disclosure should be included in the protection scope of the present disclosure.

1. A foldable food warming pad, comprising:
a panel, being bendable and provided with a heat source; and the heat source being configured to form a heating area on a first surface of the panel; and
a controller comprising: a housing, a main control circuit board, and a battery; the main control circuit board and the battery being arranged in the housing; the heat source and the battery being electrically connected to the main control circuit board respectively; and the panel being fixedly connected to a first side of the housing;
wherein the panel comprises a second surface opposite to the first surface, the second surface of the panel is provided with a plurality of support bodies, the plurality of support bodies are parallel to the first side of the housing, and the plurality of support bodies extend in a direction away from the second surface of the panel, a thickness of the panel is smaller than a thickness of the housing, and a height of the plurality of support bodies is configured to compensate for a thickness difference between the panel and the housing;
wherein the foldable food warming pad is bendable in a manner that, in a first state, the first surface of the panel is coplanar with an upper surface of the controller, and the first surface of the panel extend from an edge of the controller toward a direction away from the controller; and in a second state, at least one of the plurality of support bodies abuts against a lower surface of the controller.

2. The foldable food warming pad according to claim 1, wherein the panel is bendable in a direction toward a bottom surface of the controller to allow the panel to form a curved surface structure, and a bending amplitude of the curved surface structure is limited by the plurality of support bodies.

3. The foldable food warming pad according to claim 2, wherein the panel is provided with a plurality of support areas, each support area of the plurality of support areas expands outward from a joint center between the each support area and the second surface of the panel, and a bending range of the each support area increases outwards from the joint center.

4. The foldable food warming pad according to claim 3, wherein a bending range of the curved surface structure is limited by a distance between adjacent support bodies of the plurality of support bodies and the each support area.

5. The foldable food warming pad according to claim 1, wherein first ends of the plurality of support bodies are fixedly connected to the second surface of the panel.

6. The foldable food warming pad according to claim 5, wherein a cross-sectional area of each support body of the plurality of support bodies decreases along a direction away from a first end of the each support body.

7. The foldable food warming pad according to claim 5, wherein an outer side of the each support body is defined with a plurality of grooves extending along a longitudinal direction of the each support body.

8. The foldable food warming pad according to claim 1, wherein the first surface of the panel is covered with a heat transfer plate, and the heat transfer plate is bendable.

9. The foldable food warming pad according to claim 8, wherein the heat transfer plate comprises a heat dissipation area and an extension area, the heat dissipation area completely covers the heat source, and the extension area is arranged outside the heat dissipation area.

10. The foldable food warming pad according to claim 9, wherein one or more support bodies of the plurality of support bodies are provided on the extension area.

11. The foldable food warming pad according to claim 9, wherein the extension area covers at least a portion of the controller to allow a surface of the heat transfer plate and a surface of the controller to define a plane.

12. The foldable food warming pad according to claim 1 wherein the panel comprises a support plate for carrying the heat source, and the support plate is fixedly connected to the housing.

13. The foldable food warming pad according to claim 1, wherein the panel comprises a support plate for carrying the heat source, and the support plate is detachably connected to the housing.

14. The foldable food warming pad according to claim 13, wherein the housing of the controller comprises a first half housing and a second half housing, a first end of the support plate extends into the housing and is sandwiched between a first edge of the first half housing and a second edge of the second half housing, the first end of the support plate is provided with a strip extending toward the first half housing and defined with a groove extending toward the second half housing, the strip is mutually engaged with the first edge, and the groove is mutually engaged with the second edge.

15. The foldable food warming pad according to claim 1, wherein a plurality of electronic components are provided on the housing, the plurality of electronic components are electrically connected to the main control circuit board, and the plurality of electronic components are configured to send an instruction to the main control circuit board or respond to an information fed back by the main control circuit board.

16. The foldable food warming pad according to claim 1, wherein the controller is provided with a power input interface, the power input interface is electrically connected to the main control circuit board, and the power input interface is configured to establish a power connection with the main control circuit board from an external power supply.

17. The foldable food warming pad according to claim 1, wherein the controller is provided with a power output interface, the power output interface is electrically connected to the main control circuit board, and the power output interface is configured to establish a power connection between an external device and the battery through the main control circuit board.

18. A foldable food warming pad, comprising:
a panel, being bendable and provided with a heat source; the heat source being configured to form a heating area on a first surface of the panel; and
a controller comprising a housing; a main control circuit board being arranged in the housing, the heat source being electrically connected to the main control circuit board, and the panel being fixedly connected to a first side of the housing;
wherein the controller is provided with a power input interface, the power input interface is electrically connected to the main control circuit board, and the power input interface is configured to establish an electrical connection with the main control circuit board from an external power source;
the panel comprises a second surface opposite to the first surface, the second surface of the panel is provided with a plurality of support bodies, the plurality of support bodies are parallel to the first side of the housing, and the plurality of support bodies extend in a direction away from the second surface of the panel; and
a thickness of the panel is smaller than a thickness of the housing, and a height of the plurality of support bodies is configured to compensate for a thickness difference between the panel and the housing;
wherein the panel is provided with a plurality of support areas and a plurality of non-support areas, more heating materials are arranged in the plurality of support areas than in the plurality of non-support areas of the panel.

19. The foldable food warming pad according to claim 18, wherein the panel is bendable in a direction toward a bottom surface of the controller to allow the panel to form a curved surface structure, and a bending amplitude of the curved surface structure is limited by the plurality of support bodies.

20. The foldable food warming pad according to claim 19, wherein each support area of the plurality of support areas expands outward from a joint center between the each support area and the second surface of the panel, and a bending range of the each support area increases outwards from the joint center.
